(19) United States
(12) Patent Application Publication
(10) Pub. No.: US 2008/0105719 A1
(43) Pub. Date: May 8, 2008

(54) Cargo holding system

(76) Inventors: George D. Gates, South Jordan, UT (US); Stacey L. Gates, Riverton, UT (US)

Correspondence Address: THORPE NORTH & WESTERN, LLP., P.O. Box 1219, SANDY, UT, 84091-1219, US

(21) Appl. No.: 11/594,556

(22) Filed: Nov. 7, 2006

(51) Int. Cl. B60R 9/00

(52) U.S. Cl. 224/401; 224/545

(57) ABSTRACT

A cargo holding assembly for use with All-Terrain Vehicles (ATVs) includes a mounting bracket with a receiver coupled to the mounting bracket. The receiver has an inlet and an opposing outlet. The assembly includes a cargo rack having a tongue that is insertable through the inlet of the receiver and extendable out of the outlet of the receiver. A securable pin is removably securable within the receiver to contact the tongue at a point intermediate the inlet and the outlet. The pin applies a load to the tongue such that the tongue is pressed against a portion of each of the inlet and the outlet to create at least three points of contact that apply loads on the tongue to restrict movement of the tongue within the receiver.

### BACKGROUND OF THE INVENTION

1. Field of the Invention

The present invention relates generally to cargo holding devices and more particularly to cargo holding devices for All-Terrain Vehicles (ATVs).

2. Related Art

All-Terrain Vehicles, such as three wheelers, quad 4×4s, and side-by-side utility vehicles, are often used to transport cargo and equipment. Many ATVs are offered (or retrofitted) with cargo racks that can provide a place to secure cargo to the ATV. Usually these are fixed racks are made of a series of coplanar bars that extend across the front or rear of the vehicle to form a cargo deck.

Unfortunately, these racks are often limited in utility because they generally provide only a flat storage space of limited size. Consequently, placing odd-sized or odd-shaped specialty equipment on the racks, such as a gun case or cylindrical spray tank, can waste a considerable amount of valuable storage space. Additionally, ATV cargo racks are usually permanently attached to the ATV and cannot be resized or reshaped to hold specific equipment. Thus, cargo having an odd size or shape is not conveniently secured to the rack and often requires unique and complicated strapping or tie-down equipment in order to hold the cargo on the cargo rack.

### SUMMARY OF THE INVENTION

It has been recognized that it would be advantageous to develop a method and device for securing odd sized cargo or equipment to an ATV. In addition, it has been recognized that it would be advantageous to develop a method and device for easily customizing the size and shape of a cargo holding assembly by removing and replacing interchangeable cargo racks.

The present invention provides for a cargo holding assembly for use with All-Terrain Vehicles (ATVs) including a mounting bracket, mountable to the ATV or to intermediate bracketry attached to the ATV. A receiver can be coupled to the mounting bracket. The receiver can have an inlet and an opposing outlet. A cargo rack can have a tongue that can be insertable through the inlet of the receiver and extendable out of the outlet of the receiver. The cargo rack can extend from the tongue and away from the receiver when the tongue is inserted in the inlet. A securable pin can be removably securable within the receiver to contact the tongue at a point intermediate the inlet and the outlet. The pin can apply a load to the tongue such that the tongue is pressed against a portion of each of the inlet and the outlet to create at least three points of contact that apply loads on the tongue to restrict movement of the tongue within the receiver.

In another aspect of the invention, the cargo holding assembly can include a plurality of interchangeable cargo racks. Each cargo rack can have a tongue slidably receivable within the receiver. Additionally, each cargo rack can have a cargo space shape that is different from other of the cargo space shapes.

The present invention also provides for a method for installing a cargo rack on an All-Terrain Vehicle (ATV) including securing a mounting bracket to the ATV. An insertable end of tongue of a cargo rack can be inserted through an inlet and out of an outlet of a receiver coupled to the mounting bracket such that the cargo rack coupled to the tongue extends away from the receiver. A pin can be secured against the tongue within the receiver at a point intermediate the inlet and the outlet to apply a load to the tongue. The applied load can press the tongue against a portion of each of the inlet and outlet so as to create at least three points of contact on the tongue that restrict movement of the tongue within the receiver.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a front view of a cargo holding assembly in accordance with an embodiment of the present invention;

FIG. 2 is a cross sectional side view of the cargo holding assembly of FIG. 1, taken along section 2-2 of FIG. 1;

FIG. 3 is a top view of a cargo rack of the cargo holding assembly of FIG. 1 in accordance with an embodiment of the present invention;

FIG. 4 is a front view of the cargo rack of FIG. 3;

FIG. 5 is a side view of the cargo rack of FIG. 3;

FIG. 6 is a top view of another cargo rack for use with the cargo holding assembly of FIG. 1, in accordance with an embodiment of the present invention;

FIG. 7 is a front view of the cargo rack of FIG. 6;

FIG. 8 is a side view of the cargo rack of FIG. 6;

FIG. 9 is top view of another cargo rack for use with the cargo holding assembly of FIG. 1, in accordance with an embodiment of the present invention;

FIG. 10 is a front view of the cargo rack of FIG. 9; and

FIG. 11 is a side view of the cargo rack of FIG. 9.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The present invention provides generally for a cargo holding assembly that can be attached to an All-Terrain Vehicle (ATV). The cargo holding assembly can include a bracket that can mount to the ATV (or to some intermediate bracketry or rack structure attached to the ATV) and secure the cargo holding assembly to the ATV. A receiver can be coupled to the mounting bracket and can have an inlet and an outlet. The cargo rack assembly can also include a cargo rack that has a tongue extending from a cargo storage enclosure. The tongue can be inserted into the receiver through the inlet and can extend out of the outlet. The cargo storage enclosure can extend away from the tongue and away from the receiver when the tongue is inserted into the receiver.

A securable pin can be placed through an aperture in the receiver and can contact the tongue at a point that is between the inlet and the outlet. The pin can apply a load to the tongue in order to press the tongue against a portion inlet and a portion of the outlet. Thus, the pin creates at least three points of contact on the tongue that apply alternating opposing loads on the tongue. The at least three points of contact on the tongue can act to restrict movement of the tongue within the receiver.

Advantageously, the cargo rack can be removed from the receiver and replaced with another interchangeable cargo rack. In this way, the cargo rack assembly can be reconfigured to hold a variety of differently sized and shaped pieces of cargo or equipment. In addition, as the cargo rack can be positioned to project rearwardly from an ATV (and/or a rack installed on the ATV), the cargo rack can utilize normally unused storage space behind the ATV, freeing up additional, conventional storage space on the installed ATV rack.

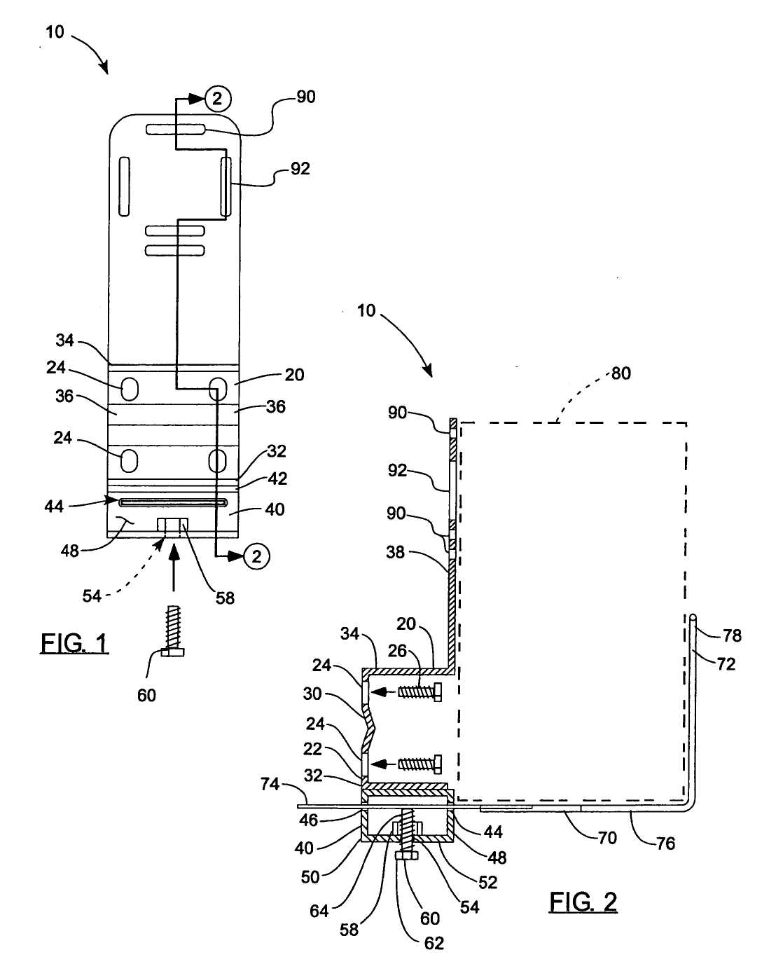

As illustrated in FIGS. 1-2, a cargo rack assembly, indicated generally at 10, is shown in accordance with an embodiment of the present invention for use in carrying cargo or equipment on an All-Terrain Vehicle. The cargo rack assembly 10 can include a mounting bracket 20, a receiver 40, and a cargo rack 70.

The mounting bracket 20 can be a U-shaped bracket that can be mounted by attaching base 22 of the U-shaped bracket to the ATV (not shown). The base 22 of the U-shaped bracket can have a plurality of apertures 24 through which fasteners 26 can be placed so as to extend into mounting structure (not shown) of the ATV. It will be appreciated that a variety of suitable fasteners 26, such as screws, bolts, and the like, can be used to attach the mounting bracket to the ATV. The side 28 of the U-shaped bracket can be at least partially open to allow access to the apertures 24 and fasteners 26.

The base 22 of the U-shape can include an indentation 30 that can be sized and shaped to fit around or over a portion of the ATV. For example, the indentation 30 can be a substantially V-shaped indentation that can fit over a tubular frame or rack member of the ATV. One or more U-bolts (not shown) can circumscribe the frame or rack member of the ATV and can extend through the apertures 24 to receive nuts (not shown) to secure the mounting bracket to the ATV.

### Advantageously, the indentation 30 can help to secure the mounting bracket 20 to the ATV by restricting movement of the bracket in at least one direction with respect to the ATV.

The receiver 40 can be a coupled to, or formed integrally with, the mounting bracket 20. In one aspect, a top 42 of the receiver 40 can be coupled to a bottom portion 32 of the mounting bracket 20, as shown in FIGS. 1-2. It will be appreciated, however, that the receiver 40 can be coupled to a top 34 or sides 36 of the mounting bracket 20 as well.

The receiver 40 can be coupled to the mounting bracket 20 by adhesive means or fastener means. For example, in one aspect, the mounting bracket 20 and receiver 40 can include a metal material and the receiver can be welded to the mounting bracket. In another aspect, the receiver 40 can include a plastic material and the receiver can be bonded to the mounting 20 bracket. In yet another aspect, the receiver 40 can include apertures through which suitable fasteners, such as screws or bolts can fasten the receiver to the mounting bracket 20.

The receiver 40 can also include an inlet 44 and an outlet 46. The inlet 44 can be positioned on one side 48 of the receiver 40, and the outlet 46 can be positioned on an opposite side 50 of the receiver. The inlet 44 can be aligned with the outlet 46 to form a path through the receiver 40 can travel and be secured. Thus, in one aspect, the receiver 40 can be a rectangular tube having a top surface 42 attached to the mounting bracket 20 and a front side 48 with the inlet 44 and a back or rear side 50 with the outlet 46.

The receiver 40 can also have a bottom 52. The bottom 52 can have an aperture 54 through which a securable pin 60 can be placed. The aperture 54 can be positioned between the front side 48 and the back side 50 so that the pin 60 can be positioned between the inlet 44 and the outlet 46 when placed in the aperture 54. In one aspect, the pin 60 can be a threaded bolt 62 and a nut 58 can be secured onto the receiver 40 adjacent the aperture 54 so that when the bolt 62 is placed through the aperture 54 the threads 64 of the bolt can engage the nut 58 and be secured into the aperture 54. In this way, the pin 60 can be secured to the receiver 40 and can remain substantially in place when secured against tongue 74.

The cargo rack 70 can have a cargo storage enclosure 72 and a tongue 74 extending from the enclosure. The tongue 74 can be sized and shaped to fit within the inlet 44 and the outlet 46 of the receiver 40. In one aspect, the tongue 74 can be a substantially flat, elongated plate oriented substantially parallel to an operating plane of the ATV. Accordingly, the inlet 44 and outlet 46 can be substantially low profile, elongated slots oriented substantially parallel to an operating plane of the ATV. The inlet and outlet slots 44 and 46 can have a height corresponding to the height of the elongated plate of the tongue 74, and a width corresponding to the width of the elongated plate of the tongue. Thus, the tongue 74 can be insertable through the inlet 44 and can extend through the receiver 40 and out of the outlet 46.

The cargo storage enclosure 72 can extend from the tongue 74 and away from the receiver 40 when the tongue is inserted into the inlet. The cargo storage enclosure 72 can be sized and shaped to hold and carry a variety of differently shaped pieces of cargo or equipment. For example, as shown in FIG. 2, the cargo storage enclosure 72 can have a substantially rectangular cross section with a bottom surface 76 and a front wall 78 extending upwardly from the bottom surface.

The front wall 78 can form a front surface of the cargo rack 70 and a back wall 38 can extend upwardly from the mounting bracket 20 to form an opposing surface to the cargo rack 70. The front wall 78 can be oriented substantially parallel to the back wall 38 and can define a cargo space 80 between the back wall and the front wall.

Thus, the cargo storage enclosure 72, shown in FIG. 2 is particularly well suited to carrying cargo having a square or rectangular shape, such as a tool box, a fishing tackle box, and the like. Advantageously, the tongue 72 can slide within the receiver 40 such that the front wall 78 can be positioned with respect to the rear wall 38 in order to selectively size the cargo storage enclosure 72 to a variety of sizes. In this way, a volume of the cargo space 80 can be adjustable as the tongue 74 slides within the receiver 40, and the cargo storage rack 10 of the present invention can thereby be adapted to carry a variety of differently sized pieces of cargo. In this manner, the storage rack 10 can be adjustable to allow consumers to tailor the size of the cargo space for a variety of types and sizes of items to be carried.

The securable pin 60 can be removably securable within aperture 54 of the receiver 40 and can contact the tongue 74 of the cargo rack 70 when the tongue is inserted into the inlet 44 and outlet 46 of the receiver 40. Because the pin 60 is positioned between the inlet 44 and the outlet 46, the pin can contact the tongue 74 at a point intermediate the inlet and the outlet. In this manner, the pin 60 can apply a load to the tongue 74 such that the tongue is pressed against a portion of each of the inlet 44 and the outlet 46 to create at least three points of contact on the tongue that apply alternating opposing loads on the tongue to restrict movement of the tongue 74 within the receiver 40.

It is a particular advantage of the present invention that the securable pin 60 can be loosened to release the tongue 74 of the cargo rack 70 so that the cargo rack 70 can be removed from the receiver 40. This allows a different cargo rack to be inserted into the receiver 40. In this way, the cargo holding assembly 10 of the present invention can include a plurality of differently shaped interchangeable cargo racks and each of the cargo racks can have a tongue 74 that is slidably receivable within the receiver 40. Additionally, each cargo rack can have a cargo space shape that is different from the cargo space shapes of the other cargo racks, and the tongue 74 of each rack can be interchangeably insertable within the receiver 40.

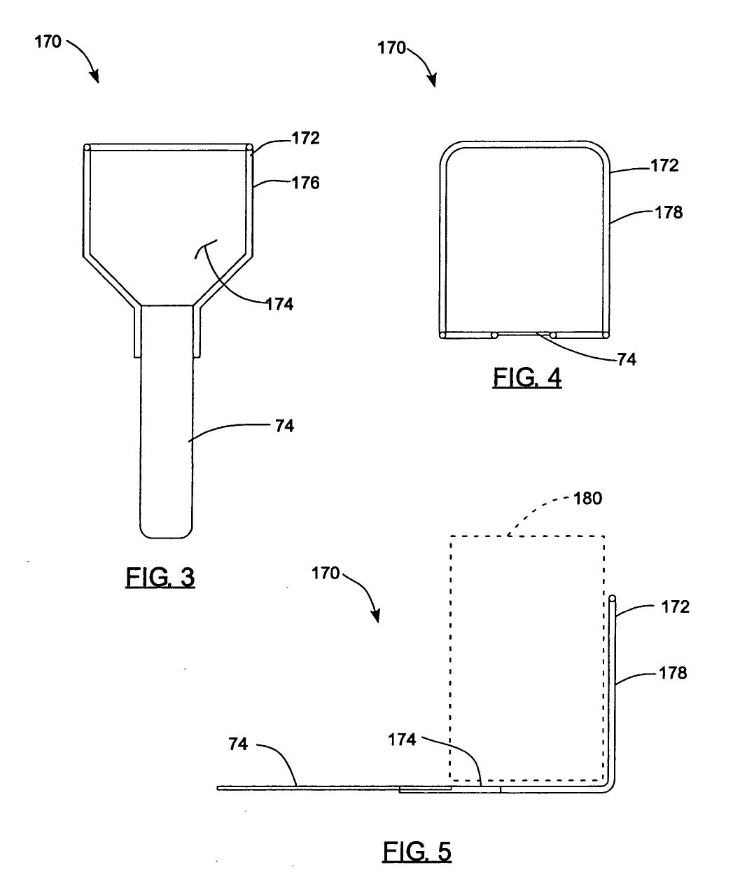

Thus, as illustrated in FIGS. 3-5, a cargo rack, indicated generally at 170, is shown in accordance with an embodiment of the present invention for use with the cargo holding assembly 10 described above and shown in FIGS. 1-2. Additionally, the cargo rack 170 can be similar in many respects to the cargo rack 70 described above and shown in FIGS. 1-2. The cargo rack 170 can have a tongue 74 and a cargo storage enclosure 172. The tongue 74 can be sized and shaped to fit within the inlet 44 and outlet 46 of the receiver 50.

The cargo storage enclosure 172 can have a substantially flat bottom plate 174 relatively larger than the tongue 74 and having an outer peripheral edge 176 with a substantially square profile. The cargo storage enclosure can also have an upwardly extending front wall 178 extending upwardly from the outer peripheral edge 176. The upwardly extending front wall 178 can form a substantially right angle with the substantially flat bottom plate 174 so that when the cargo rack 170 is inserted into the receiver 40 the substantially flat plate 174 and the upwardly extending front wall 178 define a substantially quadrangular cargo space 180. Advantageously, the quadrangular cargo space 282 of the cargo storage container 272 can be sized and shaped to hold square or rectangular storage containers such as tool boxes, fishing tackle boxes, and the like.

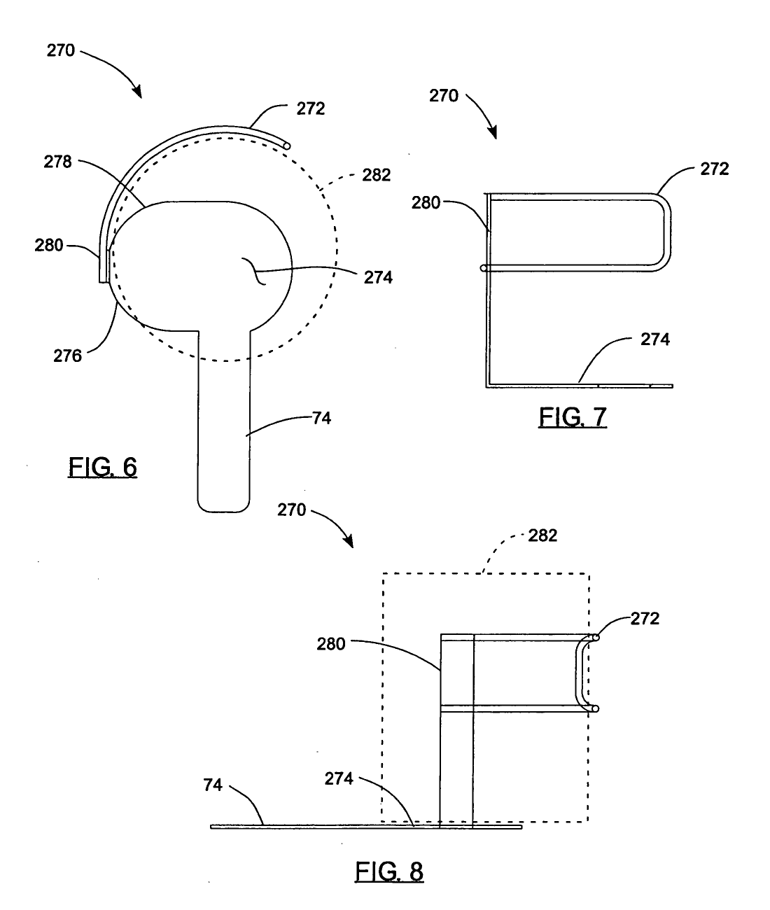

As illustrated in FIGS. 6-8, a cargo rack, indicated generally at 270, is shown in accordance with an embodiment of the present invention for use with the cargo holding assembly 10 described above and shown in FIGS. 1-2. Additionally, the cargo rack 270 can be similar in many respects to the cargo rack 70 described above and shown in FIGS. 1-2. The cargo rack 270 can have a tongue 74 and a cargo storage enclosure 272. The tongue 74 can be sized and shaped to fit within the inlet 44 and outlet 46 of the receiver 50.

The cargo storage enclosure 272 can have a substantially flat bottom plate 274 relatively larger than the tongue 74 and having an outer peripheral edge 276 with a curved side 278. An upwardly extending wall 280 can extend upwardly from the curved side 278 of the outer peripheral edge 276. The upwardly extending wall 280 can have a curved shape defining an arcuate cargo space 282 when the cargo rack 270 is inserted into the receiver 40. Advantageously, the arcuate cargo space 282 of the cargo storage container 272 can be sized and shaped to hold cylindrical storage containers such as spray tanks, water jugs, and the like.

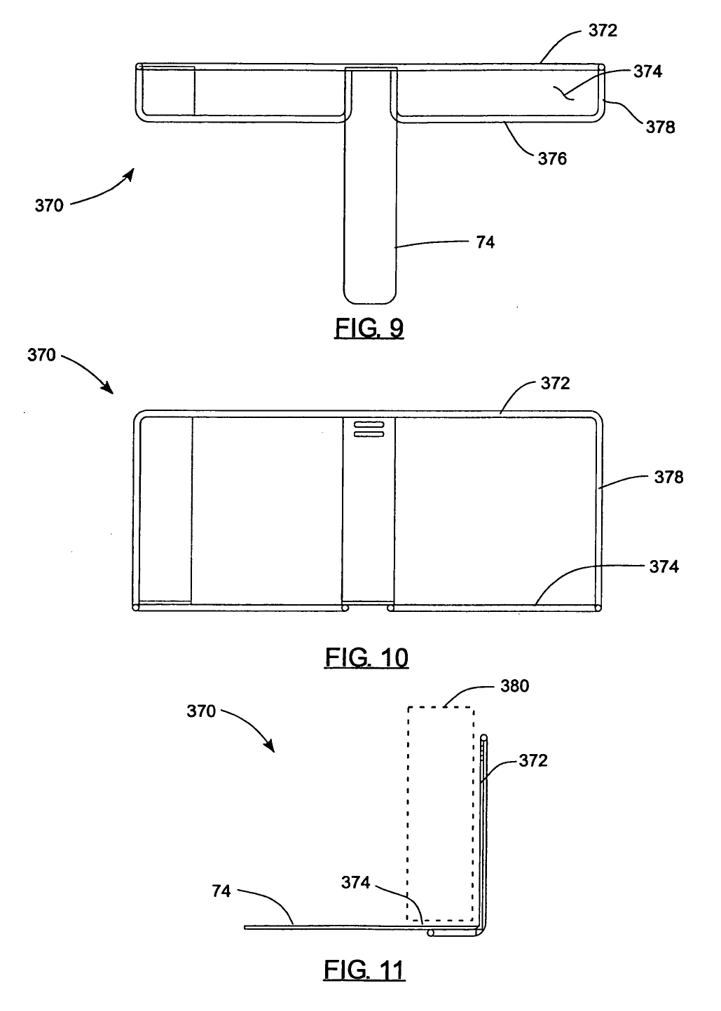

As illustrated in FIGS. 9-11, a cargo rack, indicated generally at 370, is shown in accordance with an embodiment of the present invention for use with the cargo holding assembly 10 described above and shown in FIGS. 1-2. Additionally, the cargo rack 370 can be similar in many respects to the cargo rack 70 described above and shown in FIGS. 1-2. The cargo rack 370 can have a tongue 74 and a cargo storage enclosure 372. The tongue 74 can be sized and shaped to fit within the inlet 44 and outlet 46 of the receiver 50.

The cargo storage enclosure 372 can have a substantially flat bottom plate 374 and an upwardly extending wall 378 coupled to a peripheral edge 376. The substantially flat plate 374 and the upwardly extending wall 378 can be sized and shaped to define a substantially elongate rectangular cargo space 380 with the mounting bracket 20 when the cargo rack 370 is inserted into the receiver 40. Advantageously, the cargo space 380 of the cargo storage enclosure 372 can be sized and shaped to hold a gun case, fishing rod case, or other substantially elongate rectangular cargo container.

It will be appreciated that the upwardly extending front walls of the various cargo racks 170, 270 and 370 can be a wire frame, as shown in FIGS. 3-11, or can be a solid plate to help enclose cargo within the cargo space. Other configurations for the front wall, such as expanded or perforated walls, can also be used so long as the wall adequately encloses the cargo space.

The present invention also provides for a method for installing a cargo rack on an All-Terrain Vehicle (ATV) including securing a mounting bracket to the ATV. An insertable end of tongue of a cargo rack can be inserted through an inlet and out an outlet of a receiver coupled to the mounting bracket such that the cargo rack coupled to the tongue extends away from the receiver. A pin can be secured against the tongue within the receiver at a point intermediate the inlet and the outlet to apply a load to the tongue. The applied load can press the tongue against a portion of each of the inlet and outlet so as to create at least three points of contact on the tongue that restrict movement of the tongue within the receiver. The method can also include selecting a cargo rack from a plurality of interchangeable cargo racks.

As illustrated in FIGS. 1 and 2, in one aspect of the invention, the cargo rack can include a series of receiving cavities 90, 92 that can aid in securing straps, belts, chords, and the like (not shown), to the cargo to strap or otherwise secure cargo to the rack. The cavities 90 can be used to secure a belt vertically about the cargo being held, while the cavities 92 can be used to secure a belt horizontally about the cargo being held. In addition to the cavities shown, a variety of other securing mechanisms can be used to aid in retaining cargo within the rack, including eyelets that extend from the rack, hooks, etc. Such securing mechanisms can be made adjustable to allow adjustment of these mechanisms along with the slidable features of the cargo rack 70.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

We claim:

1. A cargo holding assembly for use with All-Terrain Vehicles (ATVs), comprising:
a mounting bracket, mountable to an ATV;
a receiver, coupled to the mounting bracket and having associated therewith an inlet and an opposing outlet;
a cargo rack having a tongue extending therefrom, the tongue being insertable through the inlet of the receiver and extendable out of the outlet of the receiver, the cargo rack extending from the tongue and away from the receiver when the tongue is inserted in the inlet; and
a securable pin, removably securable within the receiver to contact the tongue at a point intermediate the inlet and the outlet, the pin applying a load to the tongue such that the tongue is pressed against a portion of each of the inlet and the outlet to create at least three points of contact that apply loads on the tongue to restrict movement of the tongue within the receiver.

2. The assembly of claim 1, wherein the tongue is a substantially flat, elongated plate oriented substantially parallel to an operating plane of the ATV.

3. The assembly of claim 1, wherein the mounting bracket further includes an upwardly extending back wall, and wherein the cargo rack includes an upwardly extending front wall oriented substantially parallel to the back wall and defining a cargo space between the back wall and the front wall, a volume of the cargo space being adjustable as the tongue slides within the receiver.

4. The assembly of claim 1, wherein the cargo rack further comprises:
a substantially flat plate relatively larger than the tongue and having an outer peripheral edge with a substantially square profile; and
an upwardly extending front wall extending upwardly from the outer peripheral edge and forming a substantially right angle with the substantially flat plate so that when the cargo rack is inserted into the receiver the substantially flat plate and the upwardly extending front wall define a substantially quadrangular cargo space.

5. The assembly of claim 1, wherein the cargo rack further comprises:
a substantially flat plate relatively larger than the tongue and having an outer peripheral edge with a curved side; and
an upwardly extending wall extending upwardly from at least one of the curved sides of the outer peripheral edge, the upwardly extending wall having a curved shape defining an arcuate cargo space when the cargo rack is inserted into the receiver.

6. The assembly of claim 1, wherein the cargo rack further comprises:
a substantially flat plate with an upwardly extending wall coupled to a peripheral edge, the substantially flat plate and the upwardly extending wall being sized and shaped to define a substantially elongate rectangular cargo space with the mounting bracket when the cargo rack is inserted into the receiver.

7. A cargo holding assembly for use with All-Terrain Vehicles (ATVs), comprising:
a mounting bracket, mountable to an ATV;
a receiver, coupled to the mounting bracket; and
a plurality of interchangeable cargo racks, each cargo rack being associated with a tongue slidably receivable within the receiver, each cargo rack having a cargo space shape differing from other of the cargo space shapes and the tongue of each rack being interchangeably insertable within the receiver.

8. The assembly of claim 7, wherein the tongue of each cargo rack is positionable within the receiver to selectively size the cargo space of each cargo rack.

9. The assembly of claim 7, wherein each of the tongues is a substantially flat, elongated plate oriented substantially parallel to an operating plane of the ATV.

10. The assembly of claim 7, wherein the mounting bracket further includes an upwardly extending back wall, and wherein at least one of the cargo rack includes an upwardly extending front wall oriented substantially parallel to the back wall and defining a cargo space between the back wall and the front wall, a volume of the cargo space being adjustable as the tongue slides within the receiver.

11. The assembly of claim 7, wherein at least one of the cargo racks further comprises:
a substantially flat plate relatively larger than the tongue and having an outer peripheral edge with a substantially square profile; and
an upwardly extending front wall extending upwardly from the outer peripheral edge and forming a substantially right angle with the substantially flat plate so that when the cargo rack is inserted into the receiver the substantially flat plate and the upwardly extending front wall define a substantially quadrangular cargo space.

12. The assembly of claim 7, wherein at least one of the cargo racks further comprises:
a substantially flat plate relatively larger than the tongue and having an outer peripheral edge with a curved side; and
an upwardly extending wall extending upwardly from at least one of the curved sides of the outer peripheral edge, the upwardly extending wall having a curved shape defining an arcuate cargo space when the cargo rack is inserted into the receiver.

13. A method for installing a cargo rack on an All-Terrain Vehicle (ATV), comprising:
securing a mounting bracket to an ATV;
inserting an insertable end of tongue of a cargo rack through an inlet and out an outlet of a receiver coupled to the mounting bracket such that the cargo rack coupled to the tongue extends away from the receiver; and
securing a pin against the tongue within the receiver at a point intermediate the inlet and the outlet to apply a load to the tongue to thereby press the tongue against a portion of each of the inlet and outlet so as to create at least three points of contact on the tongue that restrict movement of the tongue within the receiver.

14. The method of claim 13, wherein the step of inserting an insertable end of a tongue further includes selecting a cargo rack from a plurality of interchangeable cargo racks.

15. The method of claim 13, wherein the tongue is a substantially flat, elongated plate oriented substantially parallel to an operating plane of the ATV.

16. The method of claim 13, wherein the cargo rack further comprises:
a substantially flat plate relatively larger than the tongue and having an outer peripheral edge with a substantially square profile; and
an upwardly extending front wall extending upwardly from the outer peripheral edge and forming a substantially right angle with the substantially flat plate so that when the cargo rack is inserted into the receiver the substantially flat plate and the upwardly extending front wall define a substantially quadrangular cargo space.
